(19) United States
(12) Patent Application Publication
(10) Pub. No.: US 2008/0141152 A1
(43) Pub. Date: Jun. 12, 2008

(54) SYSTEM FOR MANAGING ELECTRONIC DOCUMENTS FOR PRODUCTS

(75) Inventors: LEI LI, Shenzhen (CN); PING CHEN, Shenzhen (CN); LI-SHA CHEN, Shenzhen (CN); LIANG-LIANG SONG, Shenzhen (CN); HAN-YING CHEN, Shenzhen (CN); CHEN-JING CAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRIAL CO.,LTD., Shenzhen (CN); SUTECH TRADING LIMITED, Tortola (VG)

(21) Appl. No.: 11/764,979

(22) Filed: Jun. 19, 2007

(30) Foreign Application Priority Data
Dec. 8, 2006 (CN) 200610157378.8

(51) Int. Cl. G06F 15/173; G06F 3/048

(52) U.S. Cl. 715/765; 709/203

(57) ABSTRACT

A system (100) for managing electronic documents associated with respective products (i.e., product documentation) includes a database (40) and a server (30). The database selectively stores the electronic documents. The server is electronically connected to the database and includes a loading module (301) and a processing module (302). The loading module transmits selected electronic documents to the database. The processing module includes an inquiry module (3021) configured for locating/determining related documents in the database according to a keyword; a path-generating module (3022) configured for generating path links indicating locations of the located related documents; and a maintenance module (3023) for automatically deleting selectably chosen electronic documents in the database.

### BACKGROUND

1. Technical field

The present invention relates to systems for managing electronic documents and, particularly, to a system for managing electronic documents for products (i.e., product documentation).

2. Description of the Related Art

In manufacturing corporations, a large number of differing products are widely used, maintained, produced, and/or stored. Each product can, potentially, have several electronic documents relating to various attributes of the product, such as basic information reports, measurement reports, calibration reports, user guides, and so on. The electronic documents usually are stored in various engineers' computers. In order to better manage these documents, an operator needs to collect electronic documents from each personal computer and transfer them into his/her computer. Typically, this collection process requires the operator to manually add/download new electronic documents to his/her computer and to manually delete useless electronic documents stored in his/her computer. Generally, the aforesaid method for managing electronic documents for products is time consuming and may lead to mistakes (e.g., accidental deletion of documents that should remain saved). In addition, it is inconvenient for engineers to share the electronic documents with each other, under this sort of scenario.

What is needed, therefore, is an improved system for managing electronic documents of products to overcome the above-described shortcomings.

### SUMMARY

In one aspect, a system for managing electronic documents related to a plurality of respective products is provided. The system includes a database and a server. The database stores electronic documents for the products. The server is electronically connected to the database and includes a loading module and a processing module. The loading module transmits the electronic documents to the database. The processing module includes an inquiry module configured (i.e., structured and arranged) for finding out (i.e., determining) relational/related documents in the database according to at least one keyword; a path-generating module configured for generating path links indicating locations of the found related documents; and a maintenance module configured for automatically deleting selected electronic documents in the database.

Other advantages and novel features will become more apparent from the following detailed description when taken in conjunction with the accompanying drawings.

### BRIEF DESCRIPTION OF THE DRAWINGS

Many aspects of the present system for managing electronic documents for products can be better understood with reference to the following drawings. The components in the drawings are not necessarily drawn to scale, the emphasis instead being placed upon clearly illustrating the principles of the system for managing electronic documents. Moreover, in the drawings, like reference numerals designate corresponding parts throughout the diagrams.

FIG. 1 is a block diagram showing, as a whole, a construction of a system for managing electronic documents for products, according to a present embodiment; and

FIG. 2 is a schematic diagram of a server of the system set forth in FIG. 1.

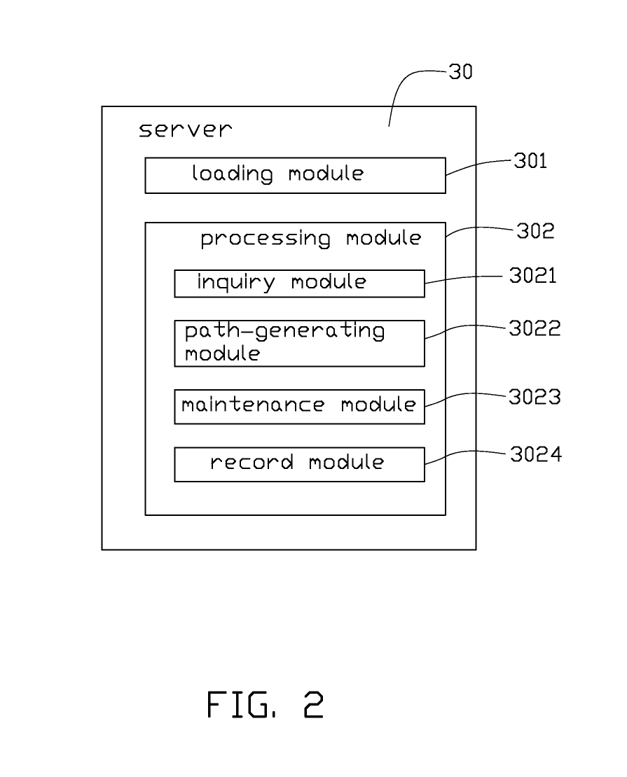

### DETAILED DESCRIPTION OF THE PREFERRED EMBODIMENT

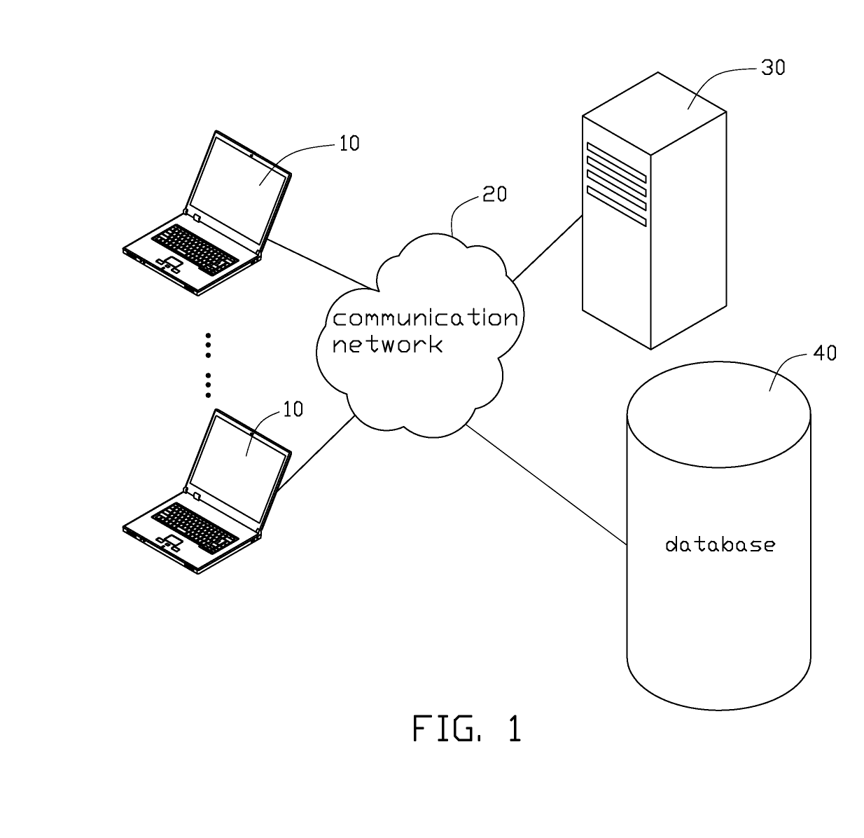

Referring now to the drawings in detail, FIG. 1 schematically shows a system 100 for managing electronic documents related to a plurality of products and/or related to plurality of separate aspects associated with a given product, in accordance with a present embodiment. The system 100 includes at least one client computer 10, a communication network 20, a server 30, and a database 40. The communication network 20 electronically connects (e.g., via hard-wire and/or wireless linking) the client computer 10, the server 30, and the database 40 to each other.

Each client computer 10 can be, for example, a personal computer (PC), a remote mainframe computer, a machine-controlled computer, a programmable logic controller (PLC), etc. Each client computer 10 advantageously includes a mail client, a user interface, and at least one folder, which stores electronic documents associated with one or more products (i.e., product documents). The mail client can be a web mail system, such as Lotus Notes® (owned by Lotus Development Corporation having a principle place of business at 55 Cambridge Parkway Cambridge, Mass. 02142, USA; and IBM Corporation having a principle place of business at New Orchard Road, Armonk, N.Y. 10504, USA) system, internet-provider-based e-mail, and so on. The mail client can transmit electronic mail to the server 30. The user interface is displayed on the client computer 10 (e.g., using a display screen). A user can interact with the user interface via input devices of the client computer 10. The input device can, for example, be a keyboard, a scanner, or a mouse. The user interface usefully includes a loading icon, a keyword input box, an inquiry icon, a path display zone, and a plurality of maintenance icons.

The communication networks 20 can be, for example, a local area network (LAN), a wide area network (WAN), an intranet, or the internet.

The server 30 beneficially includes, at a minimum, a loading module 301 and a processing module 302.

The loading module 301 can transmit at least a selected group of electronic documents stored in the predetermined folders of the client computers 10 to the database 40. When the loading icon of the user interface is activated, the loading module automatically transmits at least the selected group of electronic documents stored in the predetermined folders of the client computers 10 to the database 40. In particular, all the electronic documents stored in a given folder, a selected portion of electronic documents in one or more folders, or all the electronic documents, in sum, could be selectably chosen for transmission to the database 40, depending on the situation.

The processing module 302 opportunely includes, at least, an inquiry module 3021, a path-generating module 3022, a maintenance module 3023, and a record module 3024.

The inquiry module 3021 receives inquiry orders transmitted from the client computer 10, captures keywords contained in the inquiry orders, and locates related documents from the database 40, according to the keywords. The inquiry order can be generated when the inquiry icon of the user interface is activated or when the server 30 receives an e-mail from the mail client of the client computer 10. The keywords are inputted into the keyword input box of the user interface by a user or are contained in the e-mail. The keywords can, e.g., be a document name, a document type, keywords of/in the content of the document, loading time of the document, and so on. Such keyword-related electronic documents, upon collection thereof, can then be transferred to the database 40. It is, of course, understood that a single keyword could be used, in some instances, and the use of just one keyword is considered to be within the scope of the present system, as well.

The path-generating module 3022 generates path links indicating the locations of each related document found by the inquiry module 3021, and the client computer 10 displays the path links in the path display zone of the user interface. When a path link shown in the path display zone is activated by a user, the corresponding related document is then opened and shown on the client computer 10.

The maintenance module 3023 records a status of the electronic documents and selectably deletes electronic documents according to the status thereof. The status of the electronic documents of the products can, e.g., be labeled “in use”, “current”, “active”, “useless”, “outdated”, or “stale” (i.e., not accessed over a certain period of time), as deemed appropriate. Such a designation can be changed, for example, by an authorized user or, potentially, by a computer program (e.g., a usage tracking program). When the maintenance icon of the user interface is activated, the status of an electronic document is shown and can be changed, if so chosen. A document in a useless status can, beneficially, be set with a storing period predetermined by a user. The useless documents can be stored in the database 40 until the corresponding storing period is over. When the storing period of the useless document is over, the maintenance module 3023 automatically deletes the useless document, unless determined by a user and/or a tracking program to be active and/or useful in the interim. Thus, the user does not need to find and delete useless electronic documents manually.

The record module 3024 records maintenance operations executed by the maintenance module 3023, generates a record file, and transmits the record file into the database 40. The record files are generated primarily for the operator reviewing the maintenance operations executed by the maintenance module 3023.

The database 40 is configured to store electronic documents (e.g., product documentation) and record files generated by the record module 3024.

Understandably, the system 100 can transmit and delete electronic documents automatically and thereby prevent mistakes made by manually operations. Thus, the managing efficiency is improved, and managing process time is saved. In addition, since the electronic documents are collected and stored in the database and each engineer can get a wanted electronic document via the system, it is convenient for sharing documents resources.

It is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A system for managing electronic documents of products, comprising:
a database configured for storing electronic documents and record files; and
a server connected to the database, the server comprising a loading module and a processing module, the loading module being configured for transmitting electronic documents to the database, the processing module comprising: an inquiry module configured for locating related documents in the database, according to a keyword;
a path-generating module configured for generating path links indicating locations of the found related documents; and
a maintenance module for automatically selectably deleting electronic documents in the database.

2. The system as claimed in claim 1, further comprising at least one client computer connected to the server, wherein the client computer stores at least a portion of the electronic documents in a predetermined folder.

3. The system as claimed in claim 2, wherein the client computer comprises a mail client, and the mail client sends e-mails containing at least one keyword to the server so as to drive the inquiry module to locate related documents, according to the at least one keyword.

4. The system as claimed in claim 2, wherein the client computer comprises a user interface for interacting with a user, the user interface including a keyword input box for receiving the at least one keyword inputted by a user and an inquiry icon for driving the inquiry module to locate documents, according to the inputted at least one keyword.

5. The system as claimed in claim 4, wherein the user interface further includes a loading icon, the loading icon being configured such that, when the loading icon is activated, the loading module automatically transmits at least a selected group of electronic documents stored in the predetermined folder of the client computer to the database.

6. The system as claimed in claim 4, wherein the user interface further has a path display zone to display path links generated by the path-generating module.

7. The system as claimed in claim 6, wherein an electronic document can be opened and displayed on the client computer by activating a corresponding path link.

8. The system as claimed in claim 4, wherein the user interface further has a maintenance icon configured such that, when the maintenance icon is activated, a status of an electronic document is shown, the status further can be selectably changed and set with a storing period.

9. The system as claimed in claim 1, wherein the processing module further comprises a record module, the record module being configured for recording maintenance operations executed by the maintenance module, generating a record file associated with the maintenance operations, and transmitting the record file into the database.

10. The system as claimed in claim 1, further comprising a communication network coupling the at least one client computer to the server and coupling the server to the database.

11. The system as claimed in claim 10, wherein the communication network can be at least one item selected form the group consisting of a local area network (LAN), wide area network (WAN), intranet, and internet.
